(19) United States
(12) Patent Application Publication
(10) Pub. No.: US 2014/0198190 A1
(43) Pub. Date: Jul. 17, 2014

(54) WEARABLE SURGICAL IMAGING DEVICE WITH SEMI-TRANSPARENT SCREEN

(71) Applicant: Kris Okumu, San Francisco, CA (US)

(72) Inventor: Kris Okumu, San Francisco, CA (US)

(21) Appl. No.: 14/157,137

(22) Filed: Jan. 16, 2014

Related U.S. Application Data
(60) Provisional application No. 61/752,983, filed on Jan. 16, 2013.

(51) Int. Cl. G02B 27/01

(52) U.S. Cl. CPC G02B 27/017
USPC 348/53; 348/77

(57) ABSTRACT

A mobile, wearable imaging system, having operator eyewear with a plurality of semi-transparent lenses, a microphone, a video capture device, and an accelerometer, wherein the semi-transparent lenses provide the operator a full-forward head's up view and a view of an external image superposed on the full-forward head's up view. The system also includes a mobile multifunction controller including an image processor that receives the external image and produces the view of an external image superposed on the full-forward head's up view in the operator eyewear, an audio signal processor, a motion signal processor, a gesture sensor, a manual input device, and a general processor unit, which executes a received system command, and where symbolic data received by the controller is selectively combined with the external image superposed on the full-forward head's up view.

### CROSS-REFERENCE TO RELATED APPLICATIONS

This application claims the benefit of the following provisional application under 35 U.S.C. §119(e), which is hereby incorporated herein by reference in its entirety: U.S. Provisional Application No. 61/752,983, entitled “Wearable Device with Semi-transparent Screen and Method to Display Real-time Images during Surgical and Medical Procedures”, filed on Jan. 16, 2013.

### BACKGROUND

1. Field of the Invention

The present disclosure relates to a medical eyewear, and more specifically, the present disclosure relates to the use of a wearable operator eyewear with a bi-directional wireless communication module.

2. Description of the Related Art

Navigation and image-guided surgery allows physicians to perform medical procedures that were previously more invasive and risky to perform. With the advent of computer-navigated surgery, arthroscopic and endoscopic procedures, computerized tomography and fluoroscopy-guided procedures, physicians have been able to perform surgeries and medical procedures with less risk. Image-guided surgery systems allow the surgeon to view an image of the surgical instrument in an operating region within the patient's body.

For example, endoscopy is a procedure where a physician is able to view the internal anatomy of a patient by inserting an endoscope containing a camera and an integral light into the patient's body. Currently, the static 2D images obtained from such procedures are displayed on a monitor, which requires the physician to look away from the patient and the surgical field. This creates fatigue for the physician and increases the chance of error as the physician must reconstruct the 3D model of the 2D image and rely mainly on palpation rather than visual guidance. Additionally, the monitor takes up precious space in the operating room and the physician's view may be obstructed by other medical equipment and medical personnel.

While inventors have tried to incorporate a semi-transparent display system to an imaging system, the semi-transparent screen is still in between the patient and the physician, requiring the physician to turn his or head to look away from the patient. Thus there is a need for a wearable eyewear device connected to a multifunction controller, which would streamline medical procedures by allowing a physician to directly and simultaneously view the patient and an external image, and while viewing the operative field, remotely control the imaging system via video, motion, gesture, and voice commands obtained from a variety of computer navigation assisted and image-guided surgical devices.

### SUMMARY

What is provided is a wearable imaging system with wearable operator eyewear connected to a mobile multifunction controller, which would streamline medical procedures by allowing a physician to directly and simultaneously view the patient and an external image, and while viewing the operative field, remotely control the imaging system via video, motion, gesture, and voice commands obtained from a variety of computer navigation assisted and imagery surgical devices. An imaging system for use by an operator is provided, which includes operator eyewear having a plurality of semi-transparent lenses and coupled to a microphone, a video capture device, an accelerometer, and a gyroscope wherein the semi-transparent lenses provide the operator a full-forward head's up view and a view of an external image superposed on the full-forward head's up view.

A mobile multifunction controller (MMC) can be coupled to the eyewear. The controller can include an image processor that receives the external image and produces the view of an external image superposed on the full-forward head's up view in the operator eyewear. The controller also can include an audio signal processor which converts a received operator vocalization from the microphone into a system command. A motion signal processor can be included to convert a received motion signal from the accelerometer or the gyroscope or both into a system command. Similarly, an on-board gesture sensor can be used to convert a received gesture signal from the accelerometer or from the gyroscope or from the camera, or from a combination of such inputs into a corresponding system command. The system MMC can include a manual input device, such as a track pad, wherein a touch by the operator causes control of a graphical user interface by detecting motion of an operator's hand thereon, which can produce a system command, or symbolic data to be displayed on an operator eyewear view. The symbolic data is one of a graphical symbol or an alphanumeric symbol. The MMC also includes a general processor unit (GPU), by which a received system command is executed, and wherein symbolic data received by the GPU is selectively combined with the external image superposed on the full-forward head's up view. The imaging system is a mobile, wearable imaging system.

The external image can be provided by a preselected imaging modality. The external image of the preselected imaging modality can include at least one of an endoscopic image, an arthroscopic image, a fluoroscopic image, an ultrasound image, a computerized tomography image, a magnetic resonance image, an archived image, or a computer navigation system output. In some embodiments, the view of the external image is formatted according to a preselected medical imaging standard. The preselected medical imaging standard can be the NEMA Standard PS3, which is the Digital Imaging and Communications in Medicine (DICOM) standard. The external image superposed on the full-forward head's up view typically can be a stereoscopic image for binocular vision of the operator. However, the imaging system can be configured for monocular vision. The imaging system can include a signal converter that receives the external image and converts the external image from a first signal format to a second signal format. The signal converter further can include a video signal input board, if required.

### BRIEF DESCRIPTION OF THE DRAWINGS

Embodiment of the present invention disclosed herein are illustrated by way of example, and are not limited by the accompanying figures, in which like references indicate similar elements, and in which:

FIG. 1 is a block diagram of a wearable imaging system, in accordance with the teachings of the present invention;

FIG. 2 is a block diagram of another embodiment of a wearable imaging system, in accordance with the teachings of the present invention;

FIG. 3 is an illustration of a front view operator eyewear in the context of a wearable imaging system, in accordance with the teachings of the present invention; and

FIG. 4 is an illustration of a side view operator eyewear in the context of a wearable imaging system, in accordance with the teachings of the present invention.

Skilled artisans can appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION

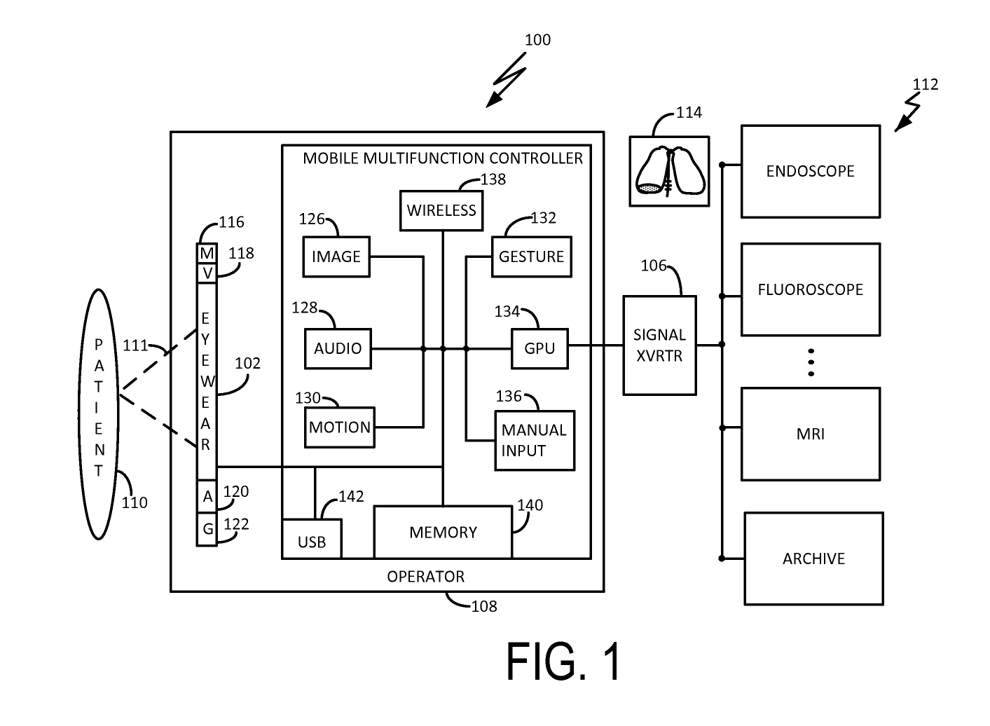

The invention provides a wearable imaging system having an immersive, stereoscopic, see-through, wearable display with multiple functions. Turning to FIG. 1, imaging system 100 includes operator eyewear 102, mobile multifunction controller (MMC) 104, and signal converter 106. Imaging system 100 is managed by operator 108, who may be performing a medical or surgical procedure on patient 110. Operator 108 may be assisted by one or more preselected imaging modalities 112. Modalities 112 can produce an external image 114, which can include, without limitation, at least one of an endoscopic image, an arthroscopic image, a fluoroscopic image, an ultrasound image, a computerized tomography image, a magnetic resonance image, an archived image, or a navigation system output. Multiple external images 134 may be used. External image 114 may be visually enhanced with symbolic data images, which symbolic data may be alphanumeric characters or graphical symbols. Operator eyewear 102 is worn by operator 108 who has, at once, a full-forward head's up view 111 of patient 110 and external image 114. Operator 108 can perform an image-guided medical or surgical procedure without looking away from patient 110 or the operative field using operator eyewear 102. External image 114 is directly within the field of view of operator 108 such that external image 114, which can be seen stereoscopically, can be overlaid on or merged into a full-forward head's up view 111 of the corresponding portion of patient 110. Such action provides operator 108 with the advantage of observing external image 114 without looking away from the corresponding portion of patient 110. In this augmented reality, operator 108, for example, can “see into” patient 110 and can observe actions of operator 108 or others within patient 110, corresponding to the medical or surgical procedure being performed.

Operator eyewear 102 can be, without limitation, an immersive, stereoscopic, see-through, wearable display, such as the MOVERIO™ BT-100 Wearable display (Model No. V11H423020) by Epson America, Long Beach, Calif. USA, although other immersive, binocular, stereoscopic, see-through, wearable displays, with a full-forward head's up view, may be used. Operator eyewear 102 also can be monocular. Operator eyewear 102 can be made of lightweight metal, plastic, composite, or other strong, lightweight material and can be worn by the physician or operator on the face during surgical or medical procedures. Eyewear 102 may be adjustable to fit many operators, may be custom-fit to an operator, or may be of a single size. Images that assist the physician or operator during the medical or surgical procedure are displayed on the semi-transparent lenses of operator eyewear 102. Eyewear 102 can be a head set with micro-projection technology, which provides a “floating” see-through display projected onto the environment, which environment can include patient 110. The operator does not need to turn his/her head or move his/her gaze from the operative field to see the external image.

Image 114 can be projected as an 80-inch perceived screen when viewed at 5 meters, having a screen resolution of 960×540 pixels at an aspect ratio of 16:9 and a transparency of up to 70%. Of course, see-though wearable displays having other specifications and features may be used. Operator eyewear 102 may be augmented with microphone 116, forward-looking point-of-view (POV) video camera 118, accelerometer 120, and gyroscope 122. Microphone 116 can be configured to detect vocalizations of operator 108, which vocalizations may be voice commands to actuate a function of system 100. Specific sounds also may be detected and may cause a system command or symbolic data to be generated. POV camera 118 can be used by operator 108 to provide a point-of-view image, for example, to remote viewers. POV camera 108 also may be used to capture operator hand gestures, which can be interpreted as a system command. Accelerometer 120 detects static and dynamic acceleration as well as tilt of the operator eyewear. Gyroscope 122 detects an angular rate of motion of the operator eyewear. Accelerometer 120 and gyroscope 122 can be used to sense a selected movement of operator 108, for example, a head nod, which can be interpreted as a system command. Operator eyewear 102 also can be outfitted with high-definition earphones (not shown). The selected movement of operator may be a gesture.

MMC 104 can include image processor 126, audio signal processor 128, motion signal processor 130, gesture sensor 132, a general processor unit 134, and a manual input device 136. MMC 104 is a mobile device that may be worn or handheld by operator 108. Operator eyewear 102 can be coupled to mobile MMC 104. MMC 104 can transmit and receive signals from operator eyewear 102. Image processor 126 can process full-forward head's up view 111 and external image 114 such that image 114 is superposed on image 111 and the composite image can be transmitted and viewed on the semi-transparent screens of operator eyewear 102. Image processor 126 also can analyze input from POV camera 118 and, for example recognize graphical codes, such as QR codes. A QR code may be representative of a system command. Image processor 126 produces a system command when a preselected QR code comes into the field of view of camera 118. Of course, other graphical symbols may be detected by POV camera 118, directed to image processor 126, and be converted into a corresponding system command.

Audio signal processor 128 can receive vocalizations of operator 108 from microphone 116, and may be programmed to recognize the vocalizations as spoken commands or narrative. For example, a spoken command may be a system command to retrieve an archived image, and a narrative may be operator 108 observations during the procedure in progress. Other preselected sounds detected in the environment of patient 110 may be converted to a system command or an annotation of the intra-operative record. However, vocalizations and sounds may take many forms and be used in a myriad of ways in system 100. In addition, audio signal processor 128 can provide the high-definition earphones (not shown) of operator eyewear 102, a preselected audio, which may be, without limitation, virtual surround sound. MMC 104 also may contain a motion processor 130, which indicates a motion signal upon input from eyewear accelerator 120 or eyewear gyroscope 122. The motion signal can be interpreted as a system command.

MMC 104 also may include a gesture sensor 132, which itself may include an accelerometer and gyroscope. Gesture sensor 132 monitors signals from one or more of accelerator 120, gyroscope 122, image processor 126, motion processor 130, manual input 136, and integrated proximity sensor, accelerometer, gyroscope for signals indicative of a preselected motion of operator 108, which then can be indicative of a gesture. In turn, gesture sensor 132 can produce a signal indicative of, without limitations, a system command or symbolic data. General processing unit (GPU) 134 can coordinate the functions of controllers 126, 128, 130, 132, 136, and wireless processor 138. GPU 134 also can execute system commands, manage signals to and from signal converter 106 and perform an executive, a monitoring, or a housekeeping operation relevant the proper functioning of system 100. Manual input 136 can be a track pad, which can receive the touch of, for example, operator 108 and can translate touch, pressure, rate of contact movement, multiple finger contact and movement (e.g., “pinch”), or duration of touch (e.g., a “tap”) into a system command or symbolic data. Manual input 136 can include joystick or trackball functionality to further enhance operation of manual input 136.

Wireless processor 138 can communicate on at least one frequency according to at least one signaling protocol. Wireless processor 138 can include, without limitation WiFi®, Bluetooth®, or near-field communication (NFC) signaling protocol capability. Other frequency bands may be used including a wireless telemetry frequency band and a preselected industrial, scientific and medical (ISM) frequency band using a predetermined signaling protocol. Processor 138 also may communicate on more than one frequency using more than one signaling protocol. Communicate can include transmission and reception. Wireless processor 138 can provide a remote display system, consultant, or data archiving device with signals received from MMC 104. Memory 140 can include internal memory and may have one or more connections for additional insertable memory. For example, MMC 104 may have 1 GB internal memory and a slot for a micromemory device, such as a 32 GB microSDHC device. Memory 140 can store system commands and routines, recognition data, templates, symbolic data or archived data, such as external image 114. It also can receive imaging data from preselected imaging modalities 112. Further, memory 140 can be configured to store data received from operator eyewear 102 and MMC 104.

A suitable device for MMC 104 can be the MOVERIO™ BT-100 Android-based controller, which is supplied with the MOVERIO™ BT-100 head set (e.g., operator eyewear 102). MMC 104 can be configured with an open source operating system, such as, the Linux kernel-based ANDROID® mobile operating system, available from GOOGLE, Mountain View, Calif. USA. The open ANDROID® mobile operating system can be customized and, through selected plug-in applications programs (“Apps”) and developer tools, makes possible functionality suitable for use with operator 108 performing and viewing a medical or surgical procedure. Other suitable operating systems and application programs may be used for MMC 104. In essence, MMC 104 can be like a mini-PC that can broadcast and receive via an ad-hoc WiFi® connection to another computer or another ANDROID® device. For example, the POV video signal can be sent to a first device, and then transmitted to a second device then to the MMC 104, which can perform image processing. The system is intended to be flexible, particularly with wireless implementations.

External connection 142 can be provided to input or receive data or both. One or more such external connections may be provided in MMC 104. MMC 104 can use, for example, a microUSB®-type connection, although an HDMI, IEEE-1394 connection, or other type of data connection may be used.

Signal converter 106 can receive imaging signals from preselected imaging modalities 112 and can convert those imaging signals from a first signal format to a second signal format, suitable for use with MMC 104. Signal converter 106 can be integrated with a video signal board, which transmits imaging signals to MMC 104. Signal converter 106 can be bidirectional, for example, in the case in which a recording of the operator 108 actions during the medical or surgical procedure needs to be analyzed or archived. In other embodiments, signal converter 106 may be integrated into MMC 104. In still other embodiments, signal converter 106 may not be used.

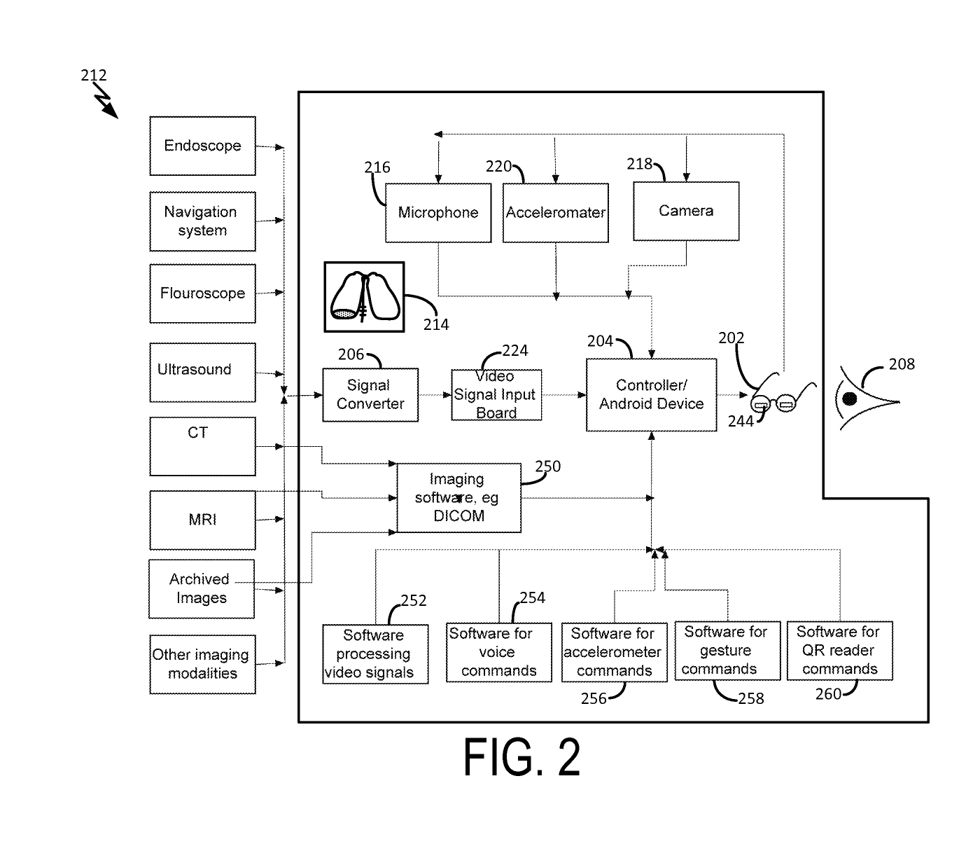

FIG. 2 provides another, graphical perspective of system 200, which can be like system 100. Application software used with system 100 can be like software programs used with system 200. System 200 can include operator eyewear 202, mobile multifunction controller (MMC) 204, signal converter 206 and video signal input board 224. Eyewear 202 can be worn on the head of operator 208. Eyewear 202 is configured to provide operator 208 with an immersive, binocular, stereoscopic, see-through, wearable displays, with a full-forward head's up view of a patient in an operative field (not shown). Eyewear 202 can permit a full-forward head's up view of the operative field without operator 208 taking his eyes off of the patient or the operative field. Eyewear 202 can have an external image 214 projected onto semi-transparent screens 244 mounted in eyewear 202. The effect is to have external image 214 from one or more imaging modality 212 superposed on the full-forward head's up view of the patient and the operative field. The operator does not need to turn his/her head or move his/her gaze from the operative field to see the external image.

Eyewear 202 also can be coupled with microphone 216, accelerometer 220, and forward-looking POV video camera 218. Microphone 216 can detect, and convert to a sound signal, preselected vocalizations by operator 208, which may be voice commands and, perhaps, selected ambient sounds from monitoring equipment coupled to the patient. Accelerometer 220 can be an <x,y,z> (3-axis) accelerometer configured to detect and convert to a motion signal based on a head movement of operator 208. Forward-looking POV video camera 218 can provide a video feed to a remote site, make a video capture of the medical or surgical procedure in progress, detect hand gestures made in the field of view of camera 218, or detect a symbolic code, such as a QR code, placed within the field of view of camera 218. A hand gesture or a QR code can symbolize a system command, with the interpretation of the signal representative of the system command being recognized in mobile multifunction controller 204. A gesture may produce a corresponding symbolic code displayed on external image 214. Eyewear 202 can be coupled with controller 204.

A suitable implementation of eyewear 202 and mobile controller 204 is the MOVERIO™ BT-100 wearable display, as described above, in which eyewear 202 is coupled to controller 204. In the BT-100 system, controller 204 can be an ANDROID™-based controller, model V11H423020, although other wearable displays using other platforms may be used. Additional information for the BT-100 system may be found at http://www.epson.com/cgi-bin/Store/jsp/Moverio/Home.do, which was active as of Jan. 10, 2014. Product specifications and a link to a user guide also are provided on the site.

Signal converter 206 and video signal input board 224 can be used to convert inbound signals from a preselected imaging modality 212 to video signals in a format suitable for mobile controller 204. One example of video signal input board 224 can be STARTECH VGA output to a composite or S-Video TV signal converter, Model VGA2VID, available from StarTech.com, Lockbourne, Ohio USA. However, in other embodiments, other signal converters may be used, or may not be used. In the embodiment of FIG. 2, separate video signal input board 224 may further condition the external image signal being provided to controller 204.

Mobile controller 204 can be programmed with various application programs to produce the functionality of the system. For example, mobile controller 204 may use imaging software 250 to convert external image data from a first format to a second format. An example of a first format includes data formatted according to DICOM standard. Many external images from selected imaging modalities have image data stored in this manner, so conversion software 250 from the DICOM standard-formatted image to an image formatted to be used by mobile controller 204.

Another type of application software program (“App”) may be App 252 used to further process video signals, for example, brightness, contrast, and other video parameters. Also, an App can be configured as voice command recognition App 254 to convert data received from microphone 216 into a corresponding system command. Accelerometer command software 256 may be used to convert a motion of operator 208 into a corresponding system command. Similarly, a motion of operator 208 may be a preselected motion from accelerometer 220, or from an accelerometer which may be integrated with controller 204, which preselected motion may be interpreted by accelerometer software 256 as a system command or can further be deemed a “gesture.” Gesture recognition software 258 can convert a preselected motion of a gesture into a corresponding system command. In addition, a code interpretation App, such as QR recognition App 260 may be configured to recognize a symbolic image from video 218 and convert the image of the code into a corresponding system command or group of commands. Software 360 may be modified to interpret other graphic codes as a system command.

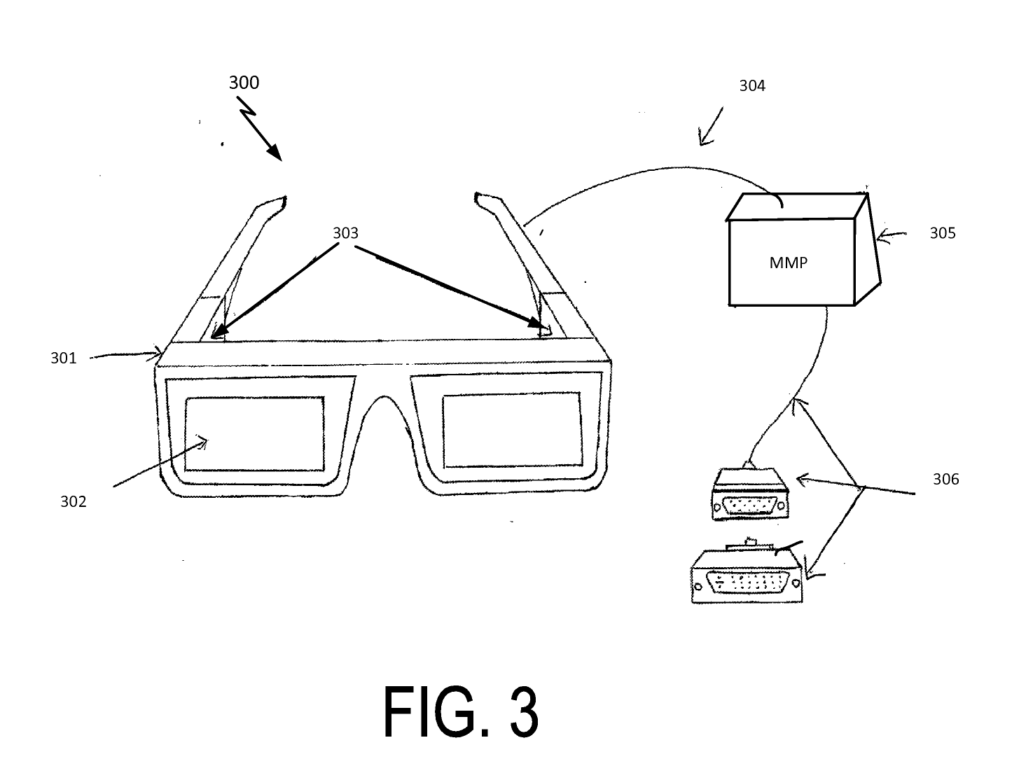

Turning to FIG. 3, a front view of operator eyewear 300 is described. Eyewear 300 is constituted of frame 301, semi-transparent lenses 302, and image processing system 303, coupled to semi-transparent lenses 302. Eyewear 300 is illustrated to be binocular, but also may be fabricated to be a monocular system. Frame 301 can be made of lightweight metal, plastic, resin, composite material, or other at least semi-rigid material. Frame 301 is configured to rest upon the face of an operator during medical or surgical procedures. Frame 301 may be adjustable to fit plural operators or may be custom-fitted to an operator. Image processing system 303 can project real-time images onto semi-transparent lenses 302. An operator can be capable of viewing an operative field and the images through lenses 302. These images can assist the operator during the performance of a medical or a surgical procedure. Image processing system 303 can be coupled to mobile multifunction platform (MMP) 305 by data cable 304. MMP 305 can be functionally similar to MMC 104 or controller 204. A suitable implementation of eyewear 300 and controller 305 is the MOVERIO™ BT-100 wearable display.

Alternately, image processing system 303 may be wirelessly coupled to MMP 305. Image processing functions can be wholly performed in image processing system 303. However, image processing functions can be shared between image processing system 303 and MMP 305. For example, MMP 305 may be configured to select or adjust the images displayed on semi-transparent screens 302, such as using a trackpad of MMP 305. MMP 305 may be coupled to receive an external image from a preselected imaging modality such as arthroscopic or endoscopic cameras, CT scanner, fluoroscope, MRI, software-assisted computer navigation hardware, or other preselected imaging modalities, using data cables 306. MMP can be configured to accept and convert the data from these preselected imaging modalities and process that data into the real-time images displayed on semi-transparent screens 302. MMP can be an ANDROID® platform, capable of be operated and manipulated by open source code, simplifying the task of building application program (“apps”) that accept and manipulate signals from the preselected imaging modalities, and other system generated signals.

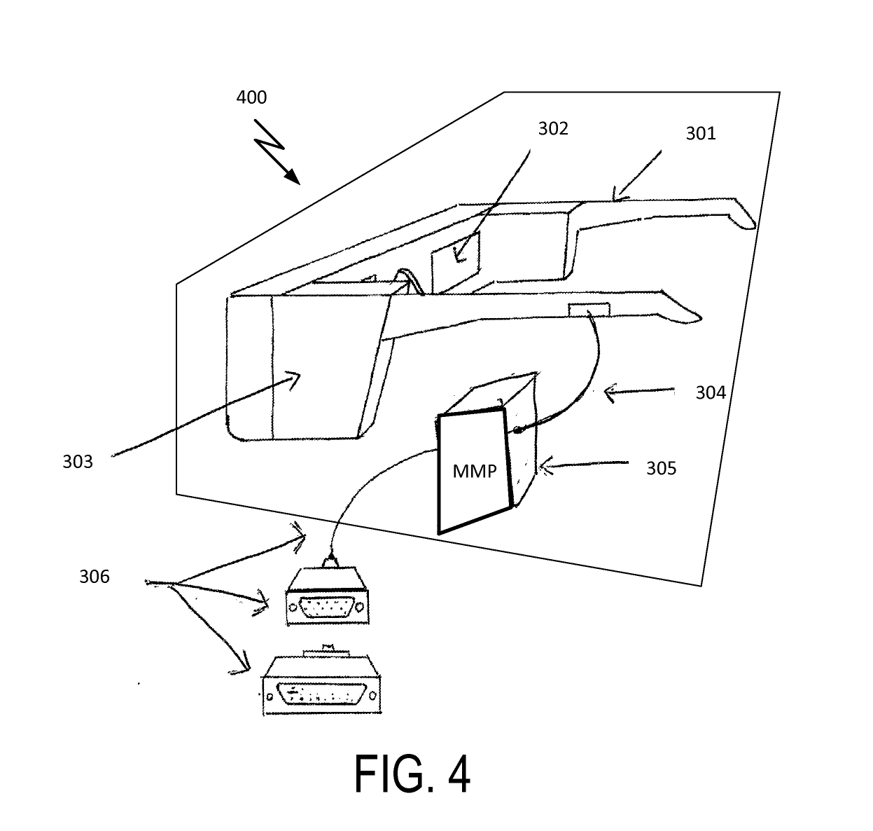

FIG. 4 is a side view of FIG. 3, imaging system 400. As with FIG. 3, operator eyewear includes frames 301, semi-transparent lenses 302, and temple-mounted imaging hardware with software. Operator eyewear communicates with MMP 305 using link 304. Link 304 may be wireless, for example, using WiFi®, Bluetooth®, near field communications, or telemetry or ISM-band wireless protocol. Similarly, one or more of the links 306 from preselected imaging modalities to MMP 305 may be made using a WiFi®, Bluetooth®, near field communications, or a wireless telemetry or ISM-band wireless protocol, as may be provided by a wireless dongle or from an imaging modality.

While this specification describes the present invention in reference to the above specific embodiments, the present invention can be modified and transformed under its substantial spirit and within its substantial scope. Therefore, the specification and the drawings thereof are provided as descriptions of a preferred embodiment rather than limitations.

What is claimed is:

1. An imaging system for use by an operator, comprising:
operator eyewear having a plurality of semi-transparent lenses and coupled to a microphone, a video capture device, and an accelerometer, wherein the semi-transparent lenses provide the operator a full-forward head's up view and a view of an external image superposed on the full-forward head's up view; and
a mobile multifunction controller coupled to the eyewear, the controller including:
an image processor that receives the external image and produces the view of an external image superposed on the full-forward head's up view in the operator eyewear,
an audio signal processor, wherein the audio signal processor converts a received operator vocalization from the microphone into a preselected system command,
a motion signal processor, wherein motion signal processor converts a received motion signal from the accelerometer into a preselected system command,
a gesture sensor, wherein the gesture sensor converts a received gesture signal from the accelerometer, or from the camera into a preselected system command,
a manual input device, wherein a touch by the operator causes control of a graphical user interface by detecting motion of an operator's hand thereon, which produces a preselected system command, or symbolic data displayed on an operator eyewear view, and
a general processor unit, wherein a received system command is executed, and wherein symbolic data received by the controller is selectively combined with the external image superposed on the full-forward head's up view,
wherein the imaging system is a mobile, wearable imaging system.

2. The imaging system of claim 1, wherein the external image is provided by a preselected imaging modality.

3. The imaging system of claim 2 wherein the external image of the preselected imaging modality includes at least one of an endoscopic image, an arthroscopic image, a fluoroscopic image, an ultrasound image, a computerized tomography image, a magnetic resonance image, an archived image, or a computer navigation system output.

4. The imaging system of claim 1 wherein the view of the external image superposed on the full-forward head's up view is formatted according to a preselected medical imaging standard.

5. The imaging system of claim 4, wherein the preselected medical imaging standard is the NEMA Standard PS3, which is the Digital Imaging and Communications in Medicine (DICOM) standard.

6. The imaging system of claim 1, wherein the external image superposed on the full-forward head's up view comprises a stereoscopic image for binocular vision of the operator.

7. The imaging system of claim 1, wherein the symbolic data is one of a graphical symbol or an alphanumeric symbol.

8. The imaging system of claim 1, further comprising a signal converter that receives the external image and converts the external image from a first signal format to a second signal format.

9. The imaging system of claim 8 wherein the signal converter further includes a video signal input board.

10. The imaging system of claim 1 wherein the mobile multifunction controller (MMC) coupled to the eyewear further comprises:
an MMC accelerometer configured to sense a preselected motion of the MMC, and to convert the preselected motion into a preselected system command.

11. The imaging system of claim 1 further comprising a gyroscope coupled to the operator eyewear, the gyroscope configured to produce an angular rate of motion of the operator eyewear.

12. The imaging system of claim 1, wherein the external image superposed on the full-forward head's up view comprises a stereoscopic image for monocular vision of the operator.

13. The imaging system of claim 1, wherein the operator eyewear further comprises a gyroscope, and wherein the gyroscope output is sensed by the motion signal processor, or the gesture sensor, and selected operator motion corresponds to a preselected system command.

14. The imaging system of claim 1, further comprising a wireless processor transmitting or receiving a signal representative of an operator eyewear signal or a mobile multifunctional controller signal.

15. The imaging system of claim 14, wherein the wireless processor operates on at least one band of a wireless medical telemetry frequency band and an industrial, scientific and medical frequency band according to a predetermined signaling protocol.

16. The imaging system of claim 15, wherein the wireless processor operates according to one of a WiFi® signaling protocol, or a Bluetooth® signaling protocol.

17. An imaging system for use by an operator, comprising:
operator eyewear having a plurality of semi-transparent lenses and coupled to a microphone, a video capture device, a gyroscope, and an accelerometer, wherein the semi-transparent lenses provide the operator a full-forward head's up view and a view of an external image provided by a preselected imaging modality and superposed on the full-forward head's up view; and
a mobile multifunction controller coupled to the operator eyewear, the controller including:
an image processor that receives the external image and produces the view of an external image superposed on the full-forward head's up view in the operator eyewear,
an audio signal processor, wherein the audio signal processor converts a received operator vocalization from the microphone into a preselected system command,
a motion signal processor, wherein motion signal processor converts a received motion signal from the accelerometer into a preselected system command,
a gesture sensor, wherein the gesture sensor converts a received gesture signal from the accelerometer, or from the camera into a preselected system command,
a wireless processor transmitting or receiving a signal representative of an operator eyewear signal or a mobile multifunctional controller signal,
a manual input device, wherein a touch by the operator causes control of a graphical user interface by detecting motion of an operator thereon, which produces a preselected system command, or symbolic data displayed on an operator eyewear view, and
a general processor unit, wherein a received system command is executed, and wherein symbolic data received by the controller is selectively combined with the external image superposed on the full-forward head's up view; and
a signal converter that receives the external image and converts the external image from a first signal format to a second signal format, wherein the mobile multifunction controller receives a signal in the second signal format,
wherein the wireless processor operates on at least one band of a wireless medical telemetry frequency band and an industrial, scientific and medical frequency band according to a predetermined signaling protocol,
wherein the imaging system is a mobile, wearable imaging system.

18. An imaging system for use by an operator, comprising:
operator eyewear having a semi-transparent lens and coupled to a microphone, a video capture device, a motion sensor providing a gesture signal, wherein the semi-transparent lens provides the operator a full-forward head's up view and a view of an external image superposed on the full-forward head's up view; and
a mobile multifunction controller coupled to the operator eyewear, the controller including:
an image processor that receives the external image from a preselected imaging modality, and produces the view of an external image superposed on the full-forward head's up view in the operator eyewear,
a gesture sensor, wherein the gesture sensor converts a received gesture signal from the motion sensor from the eyewear into a preselected system command,
a wireless processor transmitting or receiving a signal representative of an operator eyewear signal or a mobile multifunctional controller signal, and
a general processor unit, wherein a received system command is executed; and
a signal converter that receives the external image and converts the external image from a first signal format of the preselected imaging modality to a second signal format of the external image, wherein the mobile multifunction controller receives a signal in the second signal format.
